(19) United States
(12) Patent Application Publication
(10) Pub. No.: US 2025/0001532 A1
(43) Pub. Date: Jan. 2, 2025

(54) VOICE CONTROLLED JEWELRY LASER PROCESSING SYSTEM AND METHOD

(71) Applicant: Phillip D. Webb, Diamondhead, MS (US)

(72) Inventor: Phillip D. Webb, Diamondhead, MS (US)

(21) Appl. No.: 18/760,377

(22) Filed: Jul. 1, 2024

Related U.S. Application Data
(60) Provisional application No. 63/510,933, filed on Jun. 29, 2023.

(51) Int. Cl. B23K 37/02; B23K 26/04; B23K 26/082

(52) U.S. Cl. CPC B23K 37/0258; B23K 26/04; B23K 26/082

(57) ABSTRACT

A system for voice-controlled jewelry laser processing is provided. The system includes a laser processing apparatus with a workstation, a laser emitter, a and a holding means. A scanning system may generate a digital representation of the scanned portion of the jewelry and generates a scanning signal including data related to the digital representation. The control unit includes a display and is configured to receive the digital representation and move at least one of the laser emitter and the holding means by interaction of a user with the display. The voice control apparatus includes a microphone, a memory, and a processor. The processor executes the instruction set in response to the voice commands received by the microphone from the user. The voice commands include photograph, power, time, frequency, and diameter voice commands. Ways of using the system are also provided.

### CROSS-REFERENCE TO RELATED APPLICATIONS

This application claims the benefit of U.S. Provisional Application No. 63/510,933, filed on Jun. 29, 2023. The entire disclosure of the above application is hereby incorporated herein by reference.

### FIELD

The present technology relates to an apparatus for laser processing of jewelry and a method for laser processing of jewelry.

### INTRODUCTION

This section provides background information related to the present disclosure which is not necessarily prior art.

Jewelry processing is a complex and delicate task that requires precision and accuracy. Jewelry processing techniques may include the use of hand-held tools, which can be time-consuming and prone to errors. Laser processing has emerged as a promising alternative to certain hand-held-tool based techniques due to precision and speed provided by the laser. Laser processing systems, however, may be cumbersome to employ and require a skilled user to perform the processing. There is, therefore, a need for a more user-friendly and efficient system for jewelry laser processing.

Certain approaches to laser processing of jewelry focus on improving the precision and accuracy of the laser processing apparatus. In fact, a good part of precision processing with jewelry (e.g., marking, engraving, welding, and the like) may be performed with the aid of a laser beam. Laser processing approaches may employ the use of advanced scanning systems and sophisticated control units to ensure that the laser beam is directed precisely at the desired location on the jewelry. In particular, a laser beam can be collimated and aligned in the exact point in which the processing needs to be performed. In this way, the area of action of the laser is considerably reduced, thus allowing highly precise processing to be obtained. A minimum diameter of a laser beam may be on the order of a hundredth of a millimeter, for example.

Laser processing may be performed with a specific type of laser processing apparatus in which an object or work piece (e.g., jewelry) to be processed is positioned on a work surface positioned below a laser emitter configured to emit an orientable laser beam. Often the laser beam is substantially aimed along a direction orthogonal to the aforesaid work surface. The laser processing apparatus may be equipped with certain devices, referred to “mobile consoles” or “manipulators,” having controls for enabling the various functions and operations of the laser processing apparatus.

Certain laser processing apparatuses require the use of both eyepieces and provide a very small focal area for the user to visually focus on the object to be processed. A control screen for visualizing and adjusting the laser may also be limited in its capacity to assist the user in setting up and using the laser processing apparatus. In this configuration, the user may have to look away from the eyepieces, and likewise the object to processed, and instead focus their attention on the control screen in order to adjust the laser. Such an arrangement can be inefficient and can result in errors and undesirable rework.

Accordingly, there is a need for a system and method that allows for the laser processing of a object and control of the laser without requiring the user to change focus from the object, such as a piece of jewelry to the control screen for the laser. Desirably, the system and method is efficient and minimizes opportunity for both error and rework.

### SUMMARY

In concordance with the instant disclosure, a system and method that allow for the laser processing of jewelry and control of a laser without requiring the user to change focus from an object or work piece to the control screen for the laser, and which is efficient and minimizes opportunity for both error and rework, has surprisingly been discovered. The present technology includes an apparatus for laser processing of an object such as a ring, necklace, bracelet, plate, or another generic object, and a method for laser processing of the object.

In certain embodiments, a system for voice-controlled laser processing of an object by a user may include a laser processing apparatus including a workstation defining a work area, a laser emitter configured to emit a laser beam towards the work area, a holding means configured to hold the object in the work area in an operating position, a scanning system configured to scan a portion of the object and generate a digital representation of the portion of the object and a control unit including a display configured to receive the digital representation of the portion of the object, the control unit configured to operate the laser emitter and the holding means based on an interaction by the user with the display. A voice control apparatus may be in communication with the control unit of the laser processing apparatus. In certain embodiments, the voice control apparatus may include a microphone to receive a voice command from the user, a memory storing an instruction set, and a processor configured to execute the instruction set in response to the voice command from the user and control the laser processing apparatus.

In certain embodiments, a method for voice-controlled laser processing of an object may include providing a system for voice-controlled laser processing of an object by a user. For example, the system, such as described above. The method may further include receiving a voice command from the user and executing an instruction set in response to the voice command. The laser processing apparatus may be controlled based on the instruction set.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a block diagram of a system for voice-controlled laser processing of an object by a user, according to an embodiment of the present disclosure.

FIG. 2 is a flow diagram for a method for voice-controlled laser processing of an object, according to an embodiment of the present disclosure.

FIG. 3 is a schematic drawing of a user operating a system for voice-controlled laser processing of an object by a user, where the system includes a control unit having a display, according to an embodiment of the present disclosure.

FIGS. 4-7 depict a series of four screenshots of the display of the system for voice-controlled laser processing of an object by a user, illustrating aspects of the system and method of using the system, according to various embodiments of the disclosure.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present the present technology includes ways of enhancing the efficiency and precision of laser processing of an object, such as an item of jewelry and other objects through the integration of voice control capabilities. This technology allows a user to operate a laser processing apparatus using voice commands, thereby enabling the user to maintain focus on the object being processed without the need to manually adjust settings or interact with a control unit in a way that would take the focus of the user away from the object. The system may include a workstation with a laser emitter and holding means to secure the object, a scanning system to generate a digital representation of the object, and a control unit equipped with a display to facilitate user interaction based on the digital representation. The voice control apparatus may include a microphone, a memory, and a processor that may execute an instruction set in response to a voice command of the user, thereby controlling the laser emitter and other components of the system. This setup may streamline an operational workflow of the system and also reduce the likelihood of an error requiring rework, thus making the process more user-friendly and efficient.

In particular, the present technology implementing the system may be stand-alone, such that the system may not be connected to the internet for data processing and then sent back. In particular, the system may include an application embodied within the laser processing system and/or a microcontroller that may be in communication with the laser processing system, and which may communicate with the laser emitter for an adjustment of the workflow variables, and other parameters of the laser. The system may also operate as an integrated version and/or application of the laser processing system where the application may process one or more operations and/or parameters of the laser processing system local and/or using an attached microcontroller. The system may be connected to the internet and/or a remote or external server for sending a captured voice command, and processing the captured voice command which may be sent back to the laser processing system to perform an action. In particular, the present technology as implemented herein may act as stand-alone system as implemented within the laser processing system, and/or a unitary device that is selectively in communication with a control unit of the laser processing system and a server and combinations thereof, such as a blended system

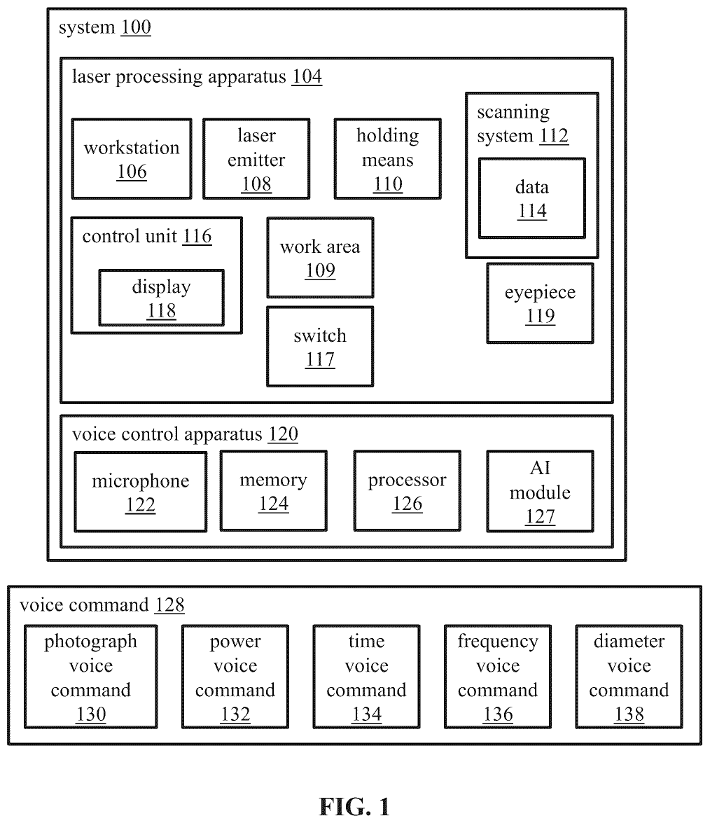

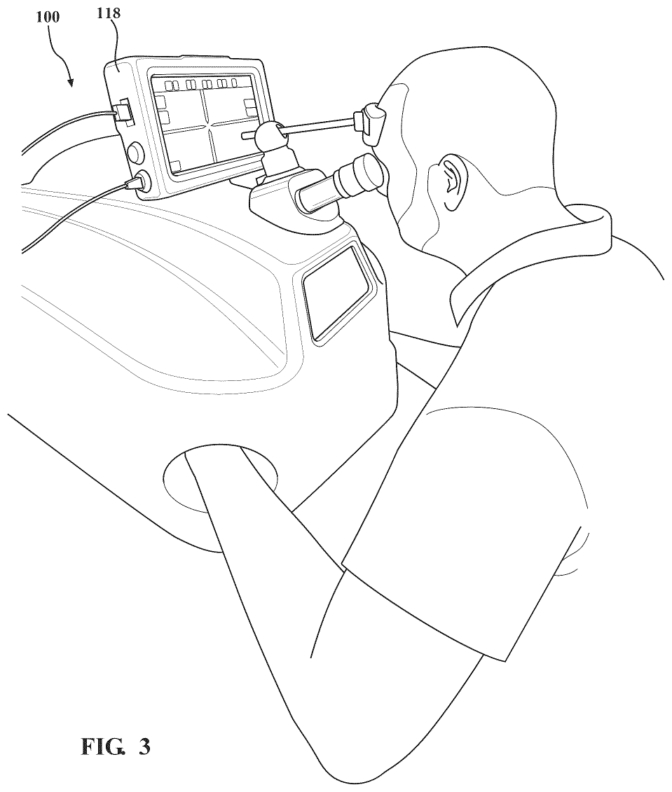

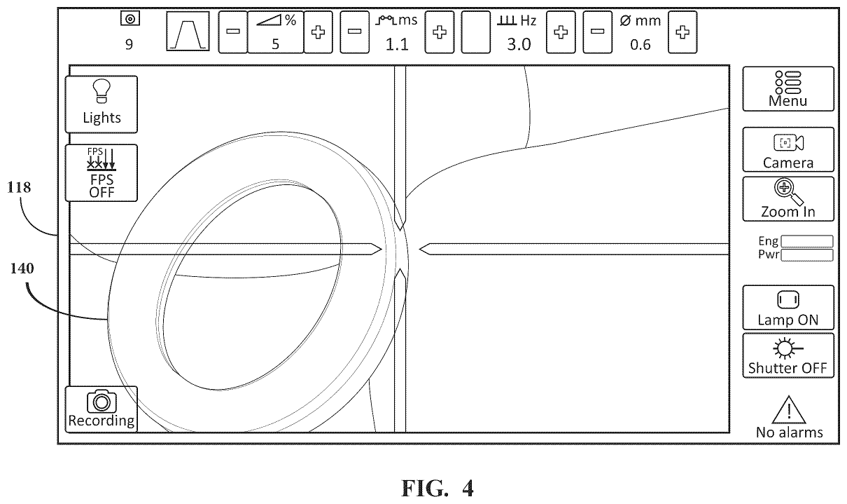

FIG. 1 is a block diagram that depicts a voice controlled laser processing system 100, according to an embodiment of the present disclosure. The voice controlled laser processing system 100 may include a laser processing apparatus 104 and a voice control apparatus 120 in communication with a control unit 116 of the laser processing apparatus 104. The laser processing apparatus 104 may further include a workstation 106 defining a work area 109 adapted to at least partially contain an object 140, such as a piece of jewelry, or other article of manufacture to be processed. The object 140 may be viewed within the workstation 106 using an eyepiece 119, as shown in FIG. 3, and the object 140 may be viewed using a display 118, as further shown in FIG. 4. The display 118 may depict the same view of the object 140 as seen through the eyepiece 119, or may depict a different magnification view of the object 140 as seen through the eyepiece 119. A laser emitter 108 may be configured to emit a laser beam towards the work area 109 in conjunction with performing a processing step on the object 140. A holding means 110 may hold the object while being processed. The holding means 110 may be configured to hold the jewelry in one or more operating positions inside the work area 109 during the operation of the laser processing apparatus 104. In certain embodiments, the voice controlled laser processing system 100 may not include the holding means 110. In this manner, the object 140 may be handheld by a user, such that the item object 140 being worked upon does not to be put down and/or reoriented during processing as the voice controlled laser processing system 100 may be controlled by a voice command to process the object 140.

The laser processing apparatus 104 may include a scanning system 112 configured to scan at least one portion of the object 140 to be processed and generate a digital representation of the scanned portion of the object 140. The scanning system 112 may include one or more digital cameras or other devices for capturing one or more images or video streams of the object 140, such as a piece of jewelry or other workpiece to be processed. The scanning system 112 may also be adapted to generate a scanning signal, where the scanning signal may include data 114 related to the digital representation of the scanned portion of the object 140.

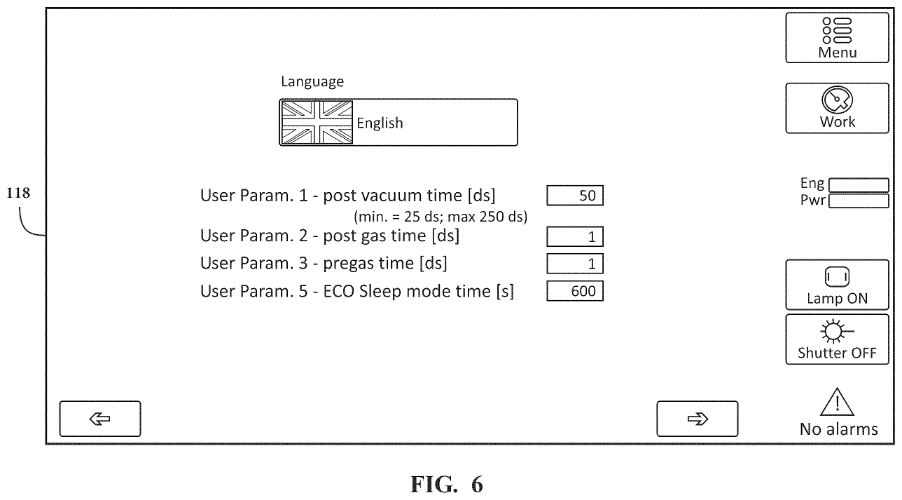

A control unit 116 may be in communication with the laser emitter 108 and the scanning system 112. The control unit 116 may be in communication with the display 118, may be configured to receive the digital representation of the object 140, and may be configured to move the laser emitter 108 and the holding means 110 by interaction of a user with the display 118 of the control unit 116. In particular, the display 118, such as shown in the series of screenshots in FIGS. 4-7, may provide a visual representation of the object 140 as well as a series of programming parameters and visual representations of a voice command 128 received by the voice control apparatus 120. The display 118 may include a touchscreen to permit the user to interface with the display 118 and the control unit 116.

In certain embodiments, the eyepiece 119 of the voice controlled laser processing system 100 may include an optical binocular microscope, or the like, for viewing the jewelry or other workpiece to be processed. It should be understood that the voice controlled laser processing system 100 can include the optical binocular microscope together with the scanning system 112 and the display 118 to facilitate the user viewing the object 140 to be processed. It should also be understood that the voice controlled laser processing system 100 can include only one of the optical binocular microscope and the scanning system 112 and the display 118 to facilitate the user viewing the jewelry or other workpiece to be processed.

The voice control apparatus 120 may include a microphone 122 or other appropriately desired apparatus configured to receive a voice command 128 from the user and a memory 124 on which an instruction set may be stored. The voice control apparatus 120 may also include a processor 126 in communication with the microphone 122 and the memory 124. The processor 126 may be configured to execute an instruction set embodied on the memory 124 in response to a voice command 128 received by the microphone 122 from the user. It should be understood that the memory 124 may be a tangible computer readable medium with the instruction set and at least one database embodied thereon. Furthermore, the processor 126 may be in communication with the control unit 116 of the laser processing apparatus 104 and configured to provide the interaction of the user with the display 118 of the control unit 116 as well as interaction of the user with the control unit 116 for providing a command directly to the control unit 116 for an operations and/or a function that may or may not be represented on the display 118, such as shown in the screenshots depicted in FIGS. 4-7.

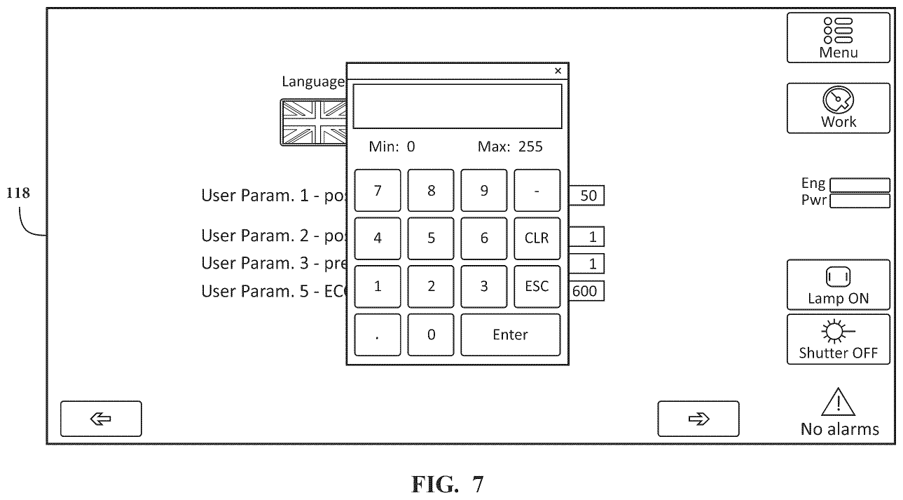

In certain embodiments, the voice control apparatus 120 may not include the display 118 and be configured for the user to provide voice commands directly to the control unit 116 for operations and/or functions of the voice controlled laser processing system 100. The voice control apparatus 120 may be configured as a unitary device that is selectively in communication with the control unit 116 of the laser processing apparatus 104. For example, the voice control apparatus 120 may be configured as a plug-and-play device configured to interface with a preexisting laser processing apparatus 104 or other appropriate device that is able to plug into an input/output port or other appropriate location in order to connect with the voice controlled laser processing system 100. Alternatively, or in conjunction, the voice control apparatus 120 may be embodied within a memory and/or a serial bus of the voice controlled laser processing system 100. The voice control apparatus 120 may also be configured to be in wireless communication with the laser processing apparatus 104. For example, the voice control apparatus 120 may be embodied within a smart device or other application in communication with the voice controlled laser processing system 100. The voice control apparatus 120 may be configured to detect whether a user has permission to use the voice controlled laser processing system 100 through a license query prior to receiving a voice command from the user. It may be necessary for the user to enter a passcode on the display 118, such as shown in the screenshot of FIG. 7. The voice controlled laser processing system 100 may further incorporate an artificial intelligence (AI) module 127 with a machine learning module for processing the voice command from the user. The voice control apparatus 120 may be configured to connect to a network.

The voice commands 128 may include commands effective to control the operation of the laser processing apparatus 104 and facilitate the performing of processes on the object 140. For example, the voice commands can include a photograph voice command 130 for acquiring photographs of the jewelry using the scanning system 112, a power voice command 132 for adjusting a power setting of the laser emitter 108, a time voice command 134 for adjusting a time setting of the laser emitter 108, a frequency voice command 136 for adjusting a frequency setting of the laser emitter 108, and a diameter voice command 138 for adjusting a diameter setting of the laser emitter 108. It should be understood that the voice commands 128 can include additional and/or other voice commands related to controlling the operation of the voice controlled laser processing system 100, the laser processing apparatus 104 and/or performing processes on the object 140.

In certain embodiments, a single voice command may launch multiple control events that would typically have to be controlled independently by hand. For example, loading a recipe may load the recipe, and also if that recipe is associated with the need to turn on or off argon as preselected in advance, then loading that recipe may also toggle the argon on or off without having to ask for it to be on or off as a separate request.

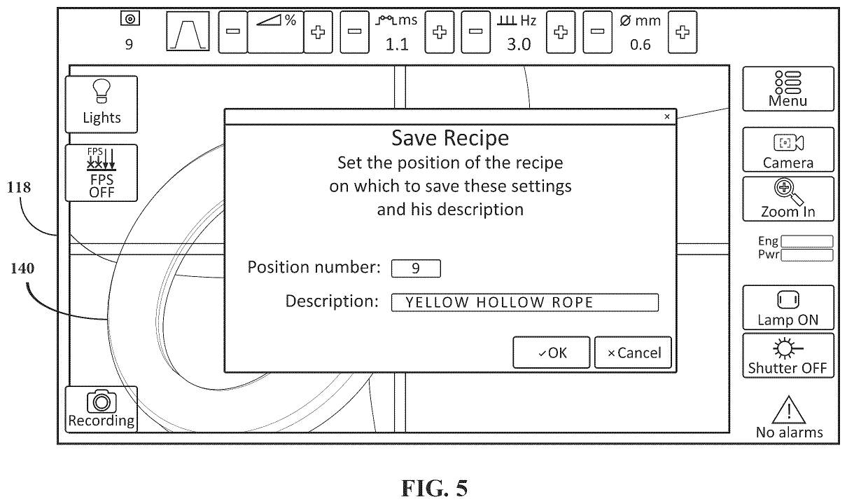

Additional commands may include loading a set of operational parameters (e.g., a recipe for performing a defined specific process such as “retip white gold prongs” or “yellow gold resizing”), such as shown within the screenshot of FIG. 5, and specific commands such as “hey laser” to wake the system or “turn on Argon”. The voice control apparatus 120 may be configured to wake the voice controlled laser processing system 100 using a switch 117 where, for example, the switch 117 may include a foot pedal.

The voice controlled laser processing system 100 may provide an auditory response or a sound to the user, where the sounds can be provided in response to the voice commands 128 from the user or to alert the user of an operational condition of the voice controlled laser processing system 100. For example, the auditory responses may include: a sound to confirm that user has activated the voice control apparatus 120 and it is actively listening for voice commands 128 from the user; another sound to notify the user the voice command was received and understood; another sound to notify the user the voice command was received but not understood; and yet another sound or sounds to inform the user of an operational issue or malfunction of the voice controlled laser processing system 100. It should be understood that the sounds can be different tones, combinations of tones, words, or combinations of words. In certain embodiments, the voice controlled laser processing system 100 may function without a need for a camera or display. For example, the voice controlled laser processing system 100 may not include a scanning system 112, such that the voice controlled laser processing system 100 may work with a manual control. In particular, the voice controlled laser processing system 100 may have a monitor with virtual control buttons. For example, the voice controlled laser processing system 100 may include manual controls. For example, the voice controlled laser processing system 100 may work with a monitor that includes only virtual buttons. A cursor may move to specific spots across the screen or display 118, such that the laser processing system 100 does not need a visual monitor. For example, a serial bus may be used to insert a command string and also receive back from the serial bus a reply that may confirm that a settings was altered as requested. This may include for example, a positive tone or a verbal reply such as, power is now set to 12 or something similar in order to inform the user the status of any settings for the voice controlled laser processing system 100. The user may even ask what is the status of the laser processing and a reply may be a response letting the user know the settings of the voice controlled laser processing system 100

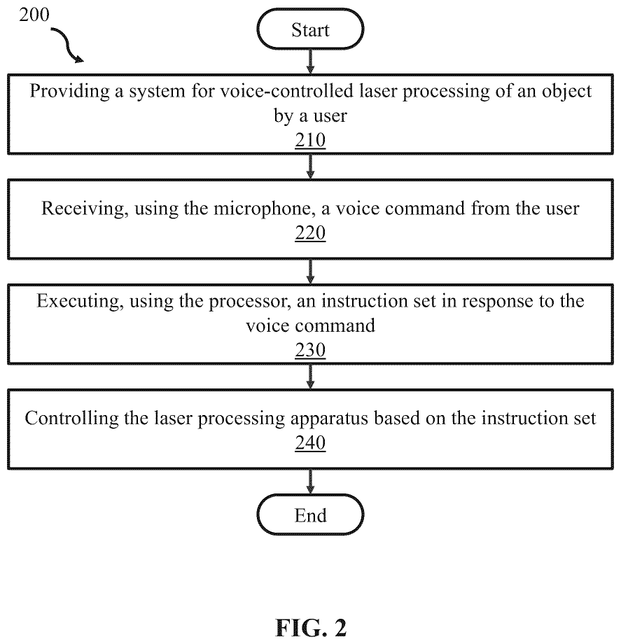

FIG. 2 is a flowchart that describes a method 200, according to an embodiment of the present disclosure. At step 210, the method may include providing a system for voice-controlled laser processing of an object 140, such as described herein. In step 220, the method 200 may further include receiving a voice command from the user and executing an instruction set in response to the voice command in step 230. Then, in step 240, the laser processing apparatus 104 may be controlled based on the instruction set. The voice commands may include, such as described herein, a photograph voice command 130 for acquiring a photograph of the object, such as an item of jewelry, a power voice command 132 for adjusting a power setting of the laser emitter 108, a time voice command 134 for adjusting a time setting of the laser emitter 108, a frequency voice command 136 for adjusting a frequency setting of the laser emitter 108, and a diameter voice command 138 for adjusting a diameter setting of the laser emitter 108.

The voice controlled laser processing system 100 and method 200 described allow a user to efficiently manage and operate the laser processing apparatus 104 while securely holding an object in the workstation 106. For example, where a user may be working on a delicate piece of jewelry that requires precise laser engraving. The user may comfortably hold the jewelry in the designated work area 109 of the workstation 106, ensuring the object 140 is positioned and stable without having to avert their gaze from the object 140 being viewed through the eyepiece 119 or as depicted on the display 118. Simultaneously, the user may use the voice control apparatus 120 to command the laser processing apparatus 104. By simply stating specific commands, as appropriately desired and as would be understood by someone of ordinary skill in the art, the user may control the laser operations without ever needing to remove their hands from the object 140 being worked on. For example, these commands may include control commands, such as described above for controlling the voice controlled laser processing system 100. These capabilities not only enhance the precision and safety of the laser processing but also enable efficiency by allowing continuous, hands-on control over the object 140 or workpiece. The seamless integration of voice-controlled operations eliminates the need to switch between manual adjustment of settings of the voice controlled laser processing system 100 and handling the object 140, thereby optimizing workflow and reducing the risk of errors or accidental damage to delicate items.

### EXAMPLES

Example embodiments of the present technology are provided with reference to the several figures including FIGS. 3-7 enclosed herewith.

### Example 1: Standard Operation of the System

In certain embodiments, the voice controlled laser processing system 100 may be used to perform detailed laser processing on a gold ring. The ring may be placed within the workstation 106, designed to securely hold various types of jewelry during laser processing. The laser processing apparatus 104 may be equipped with the laser emitter 108, and may be activated using a voice command, such as “hey laser, start,” or any other wake word, which may wake the voice controlled laser processing system 100 from a standby mode.

When the voice controlled laser processing system 100 is active, various commands, such as “power up and/or power down to a desired setting” may be issued to adjust the power setting of the laser emitter 108. For example, a power setting of the laser emitter may be selected such that the power setting is suitable for engraving gold. After completing an engraving process, a command, such as “hey laser, power off” may be given. The voice controlled laser processing system 100 may then respond with an auditory confirmation and shut down, ensuring energy efficiency and safety.

### Example 2: Advanced Feature Utilization in Complex Jewelry Design

In certain embodiments, voice commands may be used to switch between different laser settings, such as for adapting to the varying requirements for a material. Likewise, commands to take photographs during the process, such as “hey laser, capture image,” may enable precise documentation.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A voice control apparatus configured for use with a laser processing apparatus for voice-controlled laser processing of an object by a user, the laser processing apparatus including laser processing apparatus including a workstation defining a work area, a laser emitter configured to emit a laser beam towards the work area, a holding means configured to hold the object in the work area in an operating position, and a control unit, the control unit configured to operate the laser emitter and the holding means based on an interaction by the user, the voice control apparatus comprising:
a microphone to receive a voice command from the user;
a memory storing an instruction set; and
a processor configured to execute the instruction set in response to the voice command from the user and control the laser processing apparatus;
wherein the voice control apparatus is configured to be placed in selective communication with the control unit of the laser processing apparatus.

2. A system for voice-controlled laser processing of an object by a user, comprising:
a laser processing apparatus including:
a workstation defining a work area,
a laser emitter configured to emit a laser beam towards the work area,
a holding means configured to hold the object in the work area in an operating position,
a scanning system configured to scan a portion of the object and generate a digital representation of the portion of the object, and
a control unit including a display configured to receive the digital representation of the portion of the object, the control unit configured to operate the laser emitter and the holding means based on an interaction by the user with the display; and
a voice control apparatus in communication with the control unit of the laser processing apparatus, the voice control apparatus including:
a microphone to receive a voice command from the user,
a memory storing an instruction set, and
a processor configured to execute the instruction set in response to the voice command from the user and control the laser processing apparatus.

3. The system of claim 2, wherein the voice command includes a voice command including a member selected from a group consisting of a photograph voice command configured for acquiring a photograph of the object, a power voice command configured for adjusting a power setting of the laser emitter, a time voice command configured for adjusting a time setting of the laser emitter, a frequency voice command configured for adjusting a frequency setting of the laser emitter, a diameter voice command configured for adjusting a diameter setting of the laser emitter, and combinations thereof.

4. The system of claim 2, wherein the voice control apparatus is configured to detect whether the user has permission to use the system through a license query.

5. The system of claim 2, wherein the voice control apparatus incorporates artificial intelligence with a machine learning module for processing the voice command from the user.

6. The system of claim 2, wherein the voice control apparatus is configured to connect to a network.

7. The system of claim 2, wherein the voice control apparatus is configured to wake the system using a predetermined wake command.

8. The system of claim 2, wherein the voice control apparatus is configured to wake the system using a switch.

9. The system of claim 8, wherein the switch includes a foot pedal.

10. The system of claim 2, wherein the voice control apparatus is configured to provide an auditory signal to a user based on the voice command.

11. The system of claim 2, wherein the voice control apparatus is configured as a unitary device that is selectively in communication with the control unit of the laser processing apparatus.

12. The system of claim 11, wherein the voice control apparatus is configured to be in wireless communication with the laser processing apparatus.

13. The system of claim 2, wherein the object comprises an item of jewelry.

14. A method for voice-controlled laser processing of an object, the method comprising:
providing a system for voice-controlled laser processing of an object by a user according to claim 1;
receiving, using the microphone, a voice command from the user;
executing, using the processor, an instruction set in response to the voice command; and
controlling the laser processing apparatus based on the instruction set.

15. The method of claim 14, further comprising holding the object in the work area using a holding means.

16. The method of claim 14, further comprising emitting a laser beam towards the work area using a laser emitter.

17. The method of claim 14, further comprising scanning the object using a scanning system integrated into the laser processing apparatus to generate a digital representation.

18. The method of claim 14, further comprising receiving a digital representation on a control unit that includes a display and moving the laser emitter and the holding means based on user interaction with the display of the control unit.

19. The method of claim 14, wherein the voice command includes a voice command including a member selected from a group consisting of a photograph voice command configured for acquiring a photograph of the object, a power voice command configured for adjusting a power setting of the laser emitter, a time voice command configured for adjusting a time setting of the laser emitter, a frequency voice command configured for adjusting a frequency setting of the laser emitter, a diameter voice command configured for adjusting a diameter setting of the laser emitter, and combinations thereof.

20. The method of claim 14, further comprising removably coupling the voice control apparatus to the laser processing apparatus in order to place the voice control apparatus in selective communication with the control unit of the laser processing apparatus.
